(19) United States
(12) Patent Application Publication
(10) Pub. No.: US 2018/0277072 A1
(43) Pub. Date: Sep. 27, 2018

(54) MUSICAL KEYBOARD AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JUN YIN, Shenzhen (CN)

(21) Appl. No.: 15/487,450

(22) Filed: Apr. 14, 2017

(30) Foreign Application Priority Data
Mar. 22, 2017 (CN) 201710172606.7

(51) Int. Cl. G10D 15/00; G10H 1/34; G10H 1/00; G10D 11/00; H01H 13/84

(52) U.S. Cl. CPC G10D 15/00; G10H 1/344; G10H 1/0033; G10D 11/00; H01H 2231/018; G10H 2220/561; G10H 2220/275; H01H 2231/002; H01H 13/84

(57) ABSTRACT

A keyboard with a sound-generating funtion in an electronic device includes a base board, a circuit layer, a button layer, and a sound production layer. The button layer includes a first supporting board and buttons on the first supporting board. The sound production layer includes a second supporting board and sound production members on the supporting board. The sound production layer is sandwiched between the base board and the button layer, each sound production member can be contacted by a predetermined buttons. When such button is pressed, a corresponding sound production member is pressed by the button and produces sound. The electronic device is further disclosed.

### FIELD

The subject matter herein generally relates to musical keyboard and electronic devices using the musical keyboard.

### BACKGROUND

A personal computer is equipped with a keyboard as its input device. The keyboard is used for entering characters, symbols, and the like.

The control of and performance of computer synthesized music and/or computer actuated acoustic musical instruments has been achieved principally via traditional music input devices which are externally coupled to the computer. These can be external piano or organ keyboards which communicate with a computer using a standardized communication protocol such as the Musical Instrument Digital Interface (MIDI). With external keyboard systems, however, a user who wishes to generate music using a computer must make a large investment in the tools necessary to do so. Musical keyboards developed from standalone computer keyboards would be rewarding.

### BRIEF DESCRIPTION OF THE DRAWINGS

Implementations of the present technology will now be described, by way of example only, with reference to the attached figures.

FIG. 1 is an isometric view of an exemplary embodiment of an electronic device with keyboard and display connected.

FIG. 2 is a partial and exploded view of the keyboard of the electronic device of FIG. 1.

FIG. 3 is a logic diagram of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

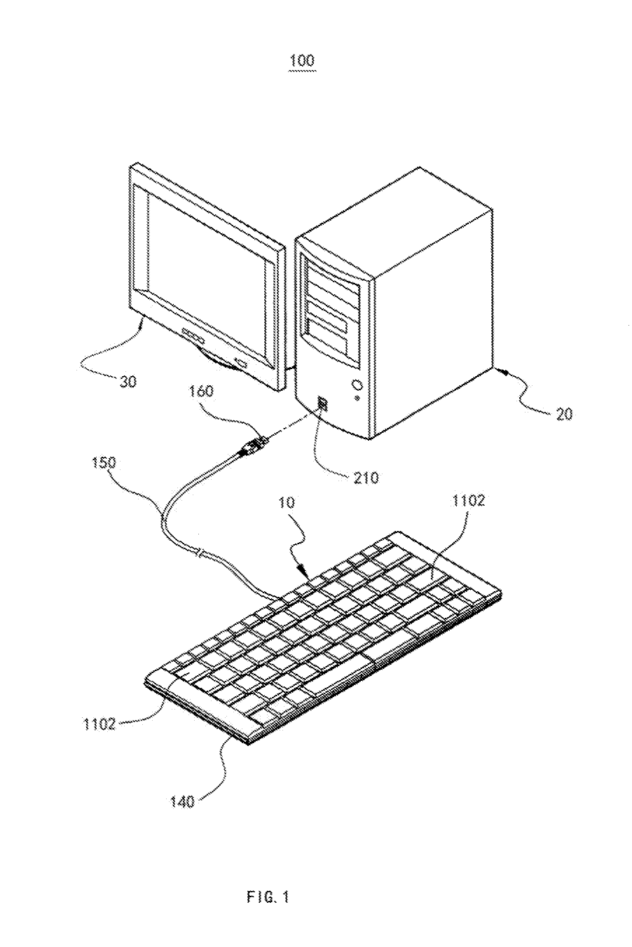

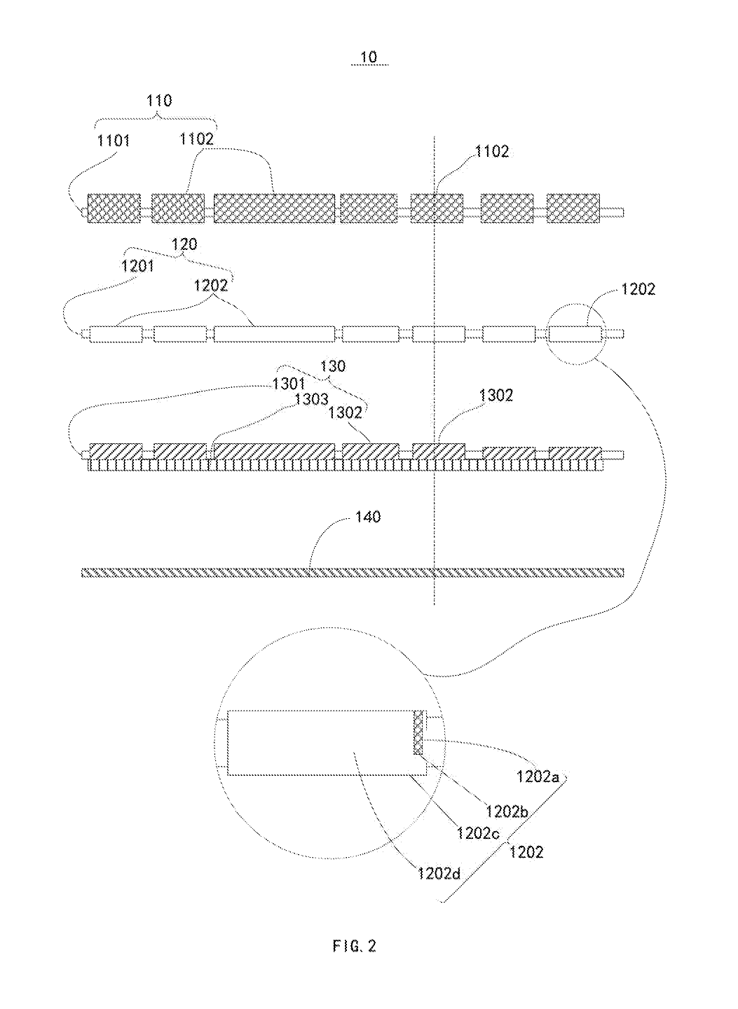

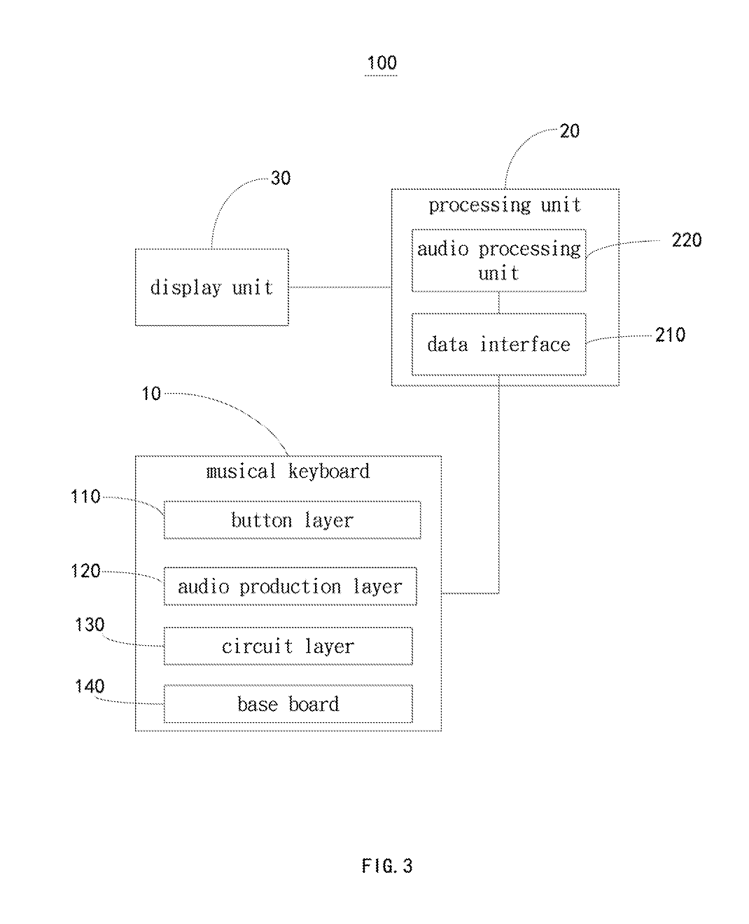

FIGS. 1 to 3 illustrate a electronic device 100 in an exemplary embodiment. The electronic device 100 can include a keyboard (musical keyboard 10) and a processing unit 20. The electronic device 100 can further include a display unit 30.

The musical keyboard 10 can include a base board 140, a circuit layer 130, a sound production layer 120, and a button layer 110. The button layer 110, the sound production layer 120, the circuit layer 130 and the base board 140 can be sequentially located from top to bottom of the musical keyboard 10.

The button layer 110 can include a first supporting board 1101 and a plurality of buttons 1102 installed on the first supporting board 1101. With the plurality of buttons 1102 installed on the first supporting board 1101, the musical keyboard 10 can be used as a regular computer keyboard.

The sound production layer 120 can include a second supporting board 1201 and a plurality of sound production members 1202 installed on the second supporting board 1201. Each of the plurality of sound production members 1202 can make contact with a predetermined one of the plurality of buttons 1102. When a button 1102 is pressed, a corresponding sound production member 1202 is pressed by the button 1102 and the sound production member 1202 produces sound. Specifically, an upper side of a sound production member 1202 can make contact with a lower side of a corresponding button 1102, thus when the button 1102 is pressed, the sound production member 1202 is activated, and the sound production member 1202 produces sound.

In at least one exemplary embodiment, each of the plurality of sound production members 1202 can include an air cushion and a vibration unit. The air cushion can include an air accommodating groove inside, a peripheral surface of the air accommodating groove defines an opening. The vibration unit mounted to the opening. When the air cushion is pressed, air in the air accommodating groove is forced through the opening, and the vibration unit is driven to produce sound by the air flow.

The air cushions of the plurality of sound production members 1202 can be different in specification. For example, each air cushion can differ from other air cushions in at least its height, width, length, or the size of its air accommodating groove, so that each sound production member 1202 can produce a unique sound.

In at least one exemplary embodiment, the circuit layer 130 can include a third supporting board 1301, an audio conversion unit (not shown) mounted to the third supporting board 1301, and a plurality of contacting members 1302. The plurality of contacting members 1302 is installed on the third supporting board 1301 and electrically connected to the audio conversion unit.

Each of the plurality of contacting members 1302 can make contact with a predetermined sound production member 1202. When a button 1102 is pressed, a corresponding sound production member 1202 is pressed by the button 1102, and a corresponding contacting member 1302 is pressed by the sound production member 1202. The audio conversion unit thus produces an audio signal according to a pressing period or a pressing pressure sensed by the contacting member 1302.

Each of the plurality of contacting members 1302 can be a variable resistor, such as a film chip resistor. When the variable resistor is pressed by a corresponding sound production member 1202, the resistance value of the variable resistor is changed, and this resistance value can be send to the audio conversion unit. The audio conversion unit produces an audio signal according to the resistance value based on a predetermined rule.

The musical keyboard 10 can further include a data cable 150 connected to the circuit layer 130 and a data plug 160 connected to the data cable 150. The musical keyboard 10 can exchange data with external devices through the data cable 150 and data plug 160 as well as get access to a power source.

The processing unit 20 can include an audio processing unit 220 and a data interface 210. The data interface 210 is connected to the audio processing unit 220.

Audio signals produced by the audio conversion unit can be send to the audio processing unit 220 through the data cable 150, data plug 160, and the data interface 210. The audio signals can be processed by the audio processing unit 220 to be played by an audio player and recorded as a file.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

1. A musical keyboard comprising:
a base board;
a circuit layer;
a button layer comprising:
a first supporting board; and
a plurality of buttons installed on the first supporting board; and
a sound production layer comprising:
a second supporting board; and
a plurality of sound production members installed on the second supporting board;
wherein the sound production layer is sandwiched between the base board and the button layer, each of the plurality of sound production members is contacted with a predetermined one of the plurality of buttons; when a button is pressed, a corresponding sound production member is pressed by the button and produces sound.

2. The musical keyboard of claim 1, wherein each of the plurality of sound production members comprises:
an air cushion comprising an air accommodating groove inside, wherein a peripheral surface of the air accommodating groove defines an opening; and
a vibration unit mounted to the opening;
when the air cushion is pressed, air in the air accommodating groove is forced to pass through the opening, the vibration unit is driven to produce sound by the air.

3. The musical keyboard of claim 2, wherein the air cushions of the plurality of sound production members are different in at least one of sizes and shapes.

4. The musical keyboard of claim 1, wherein the button layer, the sound production layer, the circuit layer and the base board are sequentially located from top to bottom.

5. The musical keyboard of claim 4, wherein the circuit layer comprises:
a third supporting board;
an audio conversion unit mounted to the third supporting board; and
a plurality of contacting members installed on the third supporting board and electrically connected to the audio conversion unit;
wherein each of the plurality of contacting members is contacted with a predetermined sound production member; when a button is pressed, a corresponding sound production member is pressed by the button, and a corresponding contacting member is pressed by the sound production member, the audio conversion unit produces an audio signal according to a pressing time period or a pressing pressure sensed by the contacting member.

6. The musical keyboard of claim 5, wherein each of the plurality of contacting members is a variable resistor; when the variable resistor is pressed by a corresponding sound production member, the resistance value of the variable resistor is changed.

7. The musical keyboard of claim 6, wherein the variable resistor is a film chip resistor.

8. The musical keyboard of claim 5, wherein the musical keyboard further comprises:
a data cable connected to the circuit layer; and
a data plug connected to the data cable.

9. An electronic device comprising:
a processing unit; and
a musical keyboard comprising:
a base board;
a circuit layer;
a button layer comprising:
a first supporting board; and
a plurality of buttons installed on the first supporting board; and
a sound production layer comprising:
a second supporting board; and
a plurality of sound production members installed on the second supporting board;
wherein the sound production layer is sandwiched between the base board and the button layer, each of the plurality of sound production members is contacted with a predetermined one of the plurality of buttons; when a button is pressed, a corresponding sound production member is pressed by the button and produces sound.

10. The electronic device of claim 9, wherein each of the plurality of sound production members comprises:
an air cushion comprising an air accommodating groove inside, wherein a peripheral surface of the air accommodating groove defines an opening; and
a vibration unit mounted to the opening;
when the air cushion is pressed, air in the air accommodating groove is forced to pass through the opening, the vibration unit is driven to produce sound by the air.

11. The musical keyboard of claim 2, wherein the air cushions of the plurality of sound production members are different in at least one of sizes and shapes.

12. The electronic device of claim 9, wherein the button layer, the sound production layer, the circuit layer and the base board are sequentially located from top to bottom.

13. The electronic device of claim 12, wherein the circuit layer comprises:
a third supporting board;
an audio conversion unit mounted to the third supporting board; and
a plurality of contacting members installed on the third supporting board and electrically connected to the audio conversion unit;
wherein each of the plurality of contacting members is contacted with a predetermined sound production member; when a button is pressed, a corresponding sound production member is pressed by the button, and a corresponding contacting member is pressed by the sound production member, the audio conversion unit produces an audio signal according to a pressing time period or a pressing pressure sensed by the contacting member.

14. The electronic device of claim 13, wherein each of the plurality of contacting members is a variable resistor; when the variable resistor is pressed by a corresponding sound production member, the resistance value of the variable resistor is changed.

15. The electronic device of claim 14, wherein the variable resistor is a film chip resistor.

16. The electronic device of claim 14, wherein the electronic device further comprises:
a data cable connected to the circuit layer; and
a data plug connected to the data cable.

17. The electronic device of claim 9, wherein the processing unit comprises:
an audio processing unit; and
a data interface connected to the audio processing unit.

18. The electronic device of claim 9, wherein the electronic device further comprises a display unit.
